(19) United States
(12) Patent Application Publication
(10) Pub. No.: US 2012/0305525 A1
(43) Pub. Date: Dec. 6, 2012

(54) METHOD OF REDUCING STRIATION ON A SIDEWALL OF A RECESS

(76) Inventors: Hsiu-Chun Lee, Taipei City (TW); Yi-Nan Chen, Taipei City (TW); Hsien-Wen Liu, Taoyuan County (TW)

(21) Appl. No.: 13/149,861

(22) Filed: May 31, 2011

(51) Int. Cl. C23F 1/00; B05D 3/10

(52) U.S. Cl. 216/37; 216/41

(57) ABSTRACT

A method of reducing striation on a sidewall of a recess is provided. The method includes the steps of providing a substrate covered with a photoresist layer. Then, the photoresist layer is etched to form a patterned photoresist layer. Later, a repairing process is performed by treating the patterned photoresist layer with a repairing gas which is selected from the group consisting of CF₄, HBr, O₂ and He. Next, the substrate is etched by taking the patterned photoresist layer as a mask after the repairing process. Finally, the patterned photoresist layer is removed.

### BACKGROUND OF THE INVENTION

1. Field of the Invention

This invention relates to a method of reducing striation on a sidewall of a recess. More particularly, it relates to use a repairing gas to repair a sidewall of a photoresist layer so as to form a smooth sidewall of a recess in a substrate.

2. Description of the Prior Art

A photoresist layer constitutes one type of resist that is commonly used in integrated circuit fabrication. The patterning of a material layer is performed by a photolithography process. For example, a photoresist layer and an anti-reflective layer, which later undergo a photochemical reaction, are formed on a particular material layer to be patterned. Next, a photo mask is used to transfer a designing pattern thereon onto to the photoresist layer by an exposure process and a development process so as to transform the photoresist layer to a patterned photoresist layer. Then, an anti-reflective coating under the patterned photoresist layer is dry etched for transferring the pattern on the patterned photoresist layer onto the anti-reflective coating.

However, during the dry etch process, some etching residuals may accumulate on the sidewall of the patterned photoresist layer randomly. Therefore, the sidewall of the photoresist layer becomes rough. Moreover, if the thickness of the photoresist layer is not enough, some striation may form on the sidewall of the patterned photoresist layer during the dry etch process.

In the end, the striation on the sidewall of the patterned photoresist layer may transfer to the material layer under the patterned photoresist layer.

### SUMMARY OF THE INVENTION

It is one object of the present invention to provide a method for reducing striation on a sidewall of a recess to solve the above-mentioned problem.

In one embodiment of the invention, a method of reducing striation on a sidewall of a recess includes: firstly, providing a substrate covered with a photoresist layer. Then, the photoresist layer is etched to form a patterned photoresist layer. Later, a repairing process is performed by treating the patterned photoresist layer with a repairing gas which is selected from the group consisting of CF₄, HBr, O₂ and He. Next, the substrate is etched by taking the patterned photoresist layer as a mask after the repairing process. Finally, the patterned photoresist layer is removed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 to FIG. 5 are diagrams showing a method of reducing striation on a sidewall of a recess according to a preferred embodiment of the present invention.

It should be noted that all the figures are diagrammatic. Relative dimensions and proportions of parts of the drawings have been shown exaggerated or reduced in size, for the sake of clarity and convenience in the drawings. The same reference signs are generally used to refer to corresponding or similar features in modified and different embodiments.

### DETAILED DESCRIPTION

In the following description, numerous specific details are given to provide a thorough understanding of the invention. However, it will be apparent to one skilled in the art that the invention may be practiced without these specific details. In order to avoid obscuring the present invention, some well-known system configurations and process steps are not disclosed in detail.

Likewise, the drawings showing embodiments of the apparatus are semi-diagrammatic and not to scale and, particularly, some of the dimensions are for the clarity of presentation and are shown exaggerated in the figures. Also, in which multiple embodiments are disclosed and described having some features in common, for clarity and ease of illustration and description thereof, like or similar features will ordinarily be described with like reference numerals.

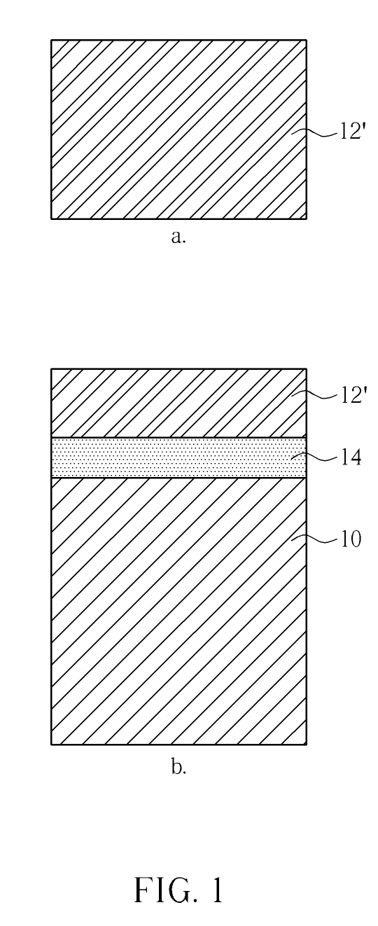

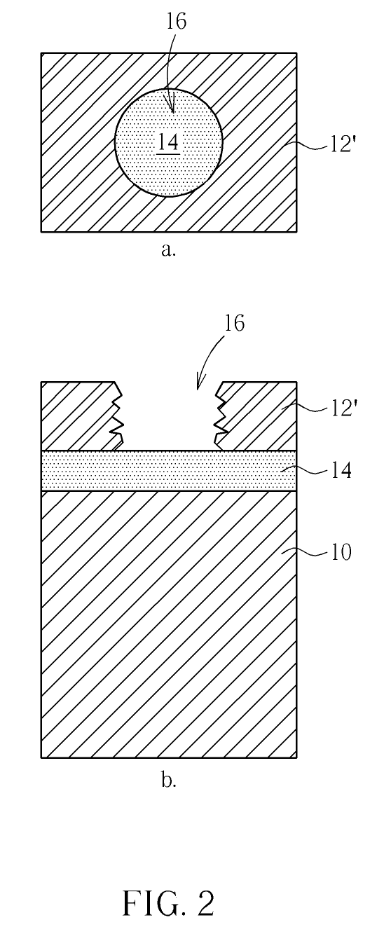

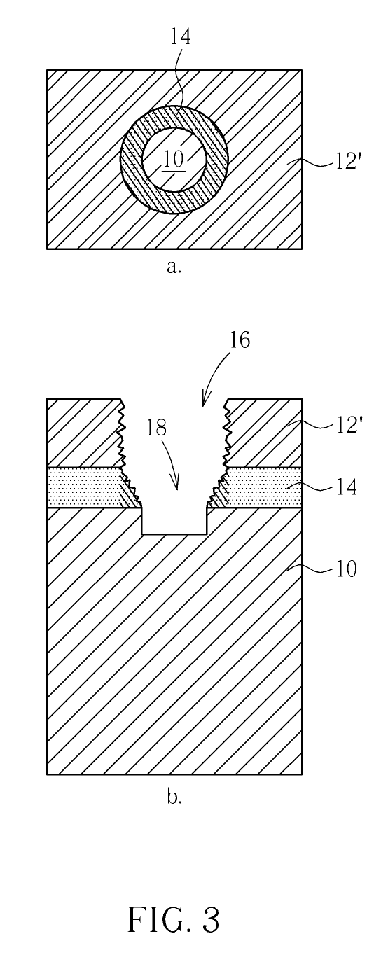

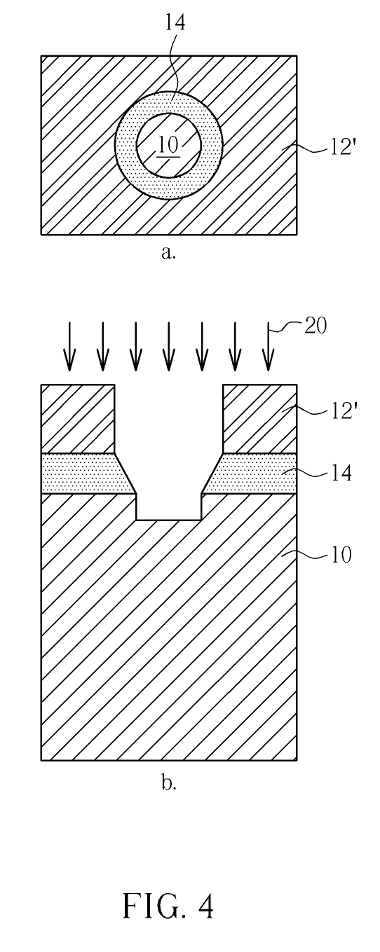

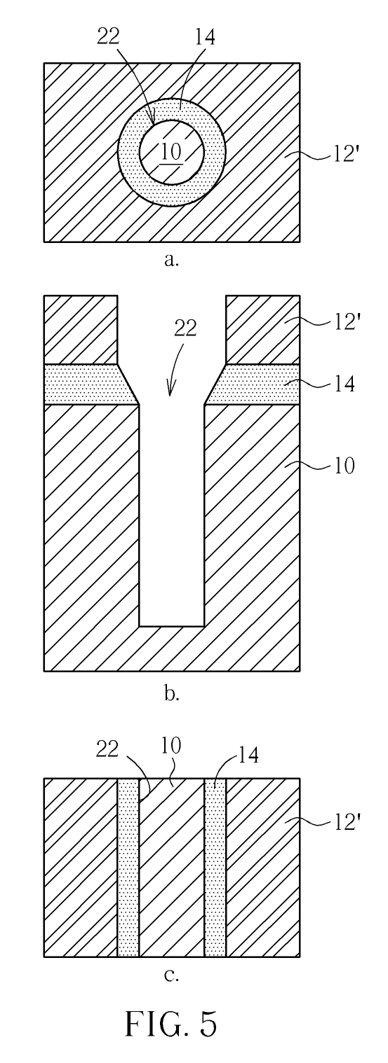

FIG. 1 to FIG. 5 are diagrams showing a method of reducing striation on a sidewall of a recess according to a preferred embodiment of the present invention. FIG. 1a shows a top view of FIG. 1b schematically. FIG. 2a shows a top view of FIG. 2b schematically. FIG. 3a shows a top view of FIG. 3b schematically. FIG. 4a shows a top view of FIG. 4b schematically. FIG. 5a shows a top view of FIG. 5b schematically. FIG. 5c shows a varied type of a top view of FIG. 5b schematically.

Please refer to FIG. 1a and FIG. 1b. A substrate 10 covered by a photoresist layer 12 is provided. The substrate 10 may be a semiconductor substrate including but not limited to silicon substrate, silicon substrate with an epitaxial layer, SiGe substrate, silicon-on-insulator (SOI) substrate, gallium arsenide (GaAs) substrate, gallium arsenide-phosphide (GaAsP) substrate, indium phosphide (InP) substrate, gallium aluminum arsenic (GaAlAs) substrate, or indium gallium phosphide (InGaP) substrate. An anti-reflective layer 14 may be optionally disposed between the substrate 10 and the photoresist layer 12. The common anti-reflection coating 14 is silicon nitride.

As shown in FIGS. 2a and 2b, firstly, the photoresist layer 12 is undergone a lithography process to form a patterned photoresist layer 12′ having a recess 16, and the anti-reflective layer 14 under the patterned photoresist layer 12′ is exposed. The recess 16 may be a pattern for forming a contact hole or a trench. It is notably that the surface of the patterned photoresist layer is striated. More specifically, the sidewall of the recess 16 is rough or striated after the lithography process. The surface of the patterned photoresist layer includes a top surface and a sidewall surface of the patterned photoresist layer 12′.

As shown in FIG. 3a and FIG. 3b, the recess 16 within the patterned photoresist layer 12′ is transferred onto the anti-reflective layer 14 by etching the anti-reflective layer 14 and taking the patterned photoresist layer 12′ as a mask. After the etching process, a recess 18 is formed within the anti-reflective layer 14. However, the striation on the patterned photoresist layer 12′ may also be transferred to the anti-reflective layer 14. As a result, the sidewall of the recess 18 is also rough or striated.

Moreover, when the anti-reflective layer 14 is etched, some etching residuals may accumulate on the surface of the patterned photoresist layer 12′ . Therefore, the sidewall of the recess 16 within the patterned photoresist layer 12′ becomes more striated.

Please refer to FIG. 4a to FIG. 4b. A repairing process 20 is performed to the patterned photoresist layer 12′ and the anti-reflective layer 14. During the repairing process 20, the patterned photoresist layer 12′ and the anti-reflective layer 14 are treated by a repairing gas. The repairing gas may include CF₄, HBr, O₂, He or combinations thereof. The repairing process 20 may be performed by treating the patterned photoresist layer 12′ and the anti-reflective layer 14 by plasma which contains the repairing gas. The repairing gas can repair the striated surface of the patterned photoresist layer 12′ and the striated surface of anti-reflective layer 14. The surface of the anti-reflective layer 14 includes the top surface and the sidewall surface of the anti-reflective layer 14. Similarity, the surface of the patterned photoresist layer 12′ includes the top surface and the sidewall surface of the patterned photoresist layer 12′.

Consequently, after the repairing process, the recesses 16, 18 within the patterned photoresist layer 12′ and the anti-reflective layer 14 respectively have smooth sidewalls. In other words, the surface of the patterned photoresist layer 12′ and the surface of the anti-reflective layer 14 become smooth.

As shown in FIGS. 5a and 5b, the substrate 10 is dry etched to form a recess 22 by taking the patterned photoresist layer 12′ and the anti-reflective layer 14 and a mask. The recess 22 can be a contact hole. Alternatively, as shown in FIG. 5c, the recess 22 can be a trench. Now, the recess 22 has a smooth sidewall, and the striation or the line edge striation is prevented. Finally, the patterned photoresist layer 12′ and the anti-reflective layer 14 can be removed optionally.

The present invention utilizes the repairing gas to repair the striation or roughness on the surface of the photoresist layer. Therefore, a recess within the substrate may have a smooth surface, especially a smooth sidewall.

Those skilled in the art will readily observe that numerous modifications and alterations of the device and method may be made while retaining the teachings of the invention.

What is claimed is:

1. A method of reducing striation on a sidewall of a recess, comprising:
providing a substrate covered with a photoresist layer;
patterning the photoresist layer to form a patterned photoresist layer;
performing a repairing process by treating the patterned photoresist layer with a repairing gas, wherein the repairing gas comprises CF₄, HBr, O₂ or He; and
etching the substrate by taking the patterned photoresist layer as a mask after the repairing process.

2. The method of reducing striation on a sidewall of a recess of claim 1, wherein the patterned photoresist layer before treated by the repairing gas has a striated surface.

3. The method of reducing striation on a sidewall of claim 1, wherein the patterned photoresist layer after treated by the repairing gas has a smooth surface.

4. The method of reducing striation on a sidewall of a recess of claim 1, wherein the repairing process comprises treating the patterned photoresist layer with plasma containing the repairing gas.

5. The method of reducing striation on a sidewall of a recess of claim 1, wherein after the substrate is etched by taking the patterned photoresist layer as a mask, a recess is formed in the substrate.

6. The method of reducing striations on a sidewall of a recess of claim 5, the recess comprises a contact hole or a trench.

7. The method of reducing striation on a sidewall of a recess of claim 1, wherein an anti-reflective coating is disposed between the substrate and the photoresist layer.

8. The method of reducing striation on a sidewall of a recess of claim 7, further comprising after the patterned photoresist layer is formed and before the repairing process is performed, etching the anti-reflective coating by taking the patterned photoresist layer as a mask.
